(19) United States
(12) Patent Application Publication
(10) Pub. No.: US 2003/0097648 A1
(43) Pub. Date: May 22, 2003

(54) Method and apparatus for determining runtime size and type information in dynamically typed languages

(76) Inventor: David S. Allison, San Ramon, CA (US)

Correspondence Address: J.D. Harriman II, COUDERT BROTHERS LLP, 23rd Floor, 333 South Hope Street, Los Angeles, CA, 90071, US

(21) Appl. No.: 09/977,513

(22) Filed: Oct. 12, 2001

(51) Int. Cl. G06F 9/44

(52) U.S. Cl. 717/114; 717/116

(57) ABSTRACT

The present invention provides a method and apparatus for determining runtime size and type information in dynamically typed languages. In one embodiment of the present invention, a dynamic size and type system is added to a programming language. In one embodiment, an operator which returns a size associated with an object is dynamically executed at runtime. In another embodiment, if the object is an instance of a class, then the class may provide an instance of its own size operator to perform the calculation. In another embodiment, an operator which returns a type associated with an object is dynamically executed at runtime. In one embodiment, if the object is an instance of a class, then the class may provide an instance of its own type operator to perform the calculation.

### BACKGROUND OF THE INVENTION

1. Field of the Invention

The present invention relates to the field of programming languages, and in particular to a method and apparatus for determining runtime size and type information in dynamically typed languages.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

In programming languages, it is sometimes desirable to be able to determine the size or type of an object. Some statically compiled languages offer a sizeof or typeof operator to determine the size or type of an object. In these languages, the size or type is determined at compile time. For example, the sizeof operator is compiled into a constant at compile time. However, in a dynamically typed language, the size and type information are not always available at compile time. This problem can be better understood by a review of programming languages.

Programming Languages

Programming languages are used to express a set of detailed instructions for a digital computer. A programming language consists of characters and rules for combining them into symbols and words.

Many kinds of programming languages have been developed over the years. Initially programmers wrote instructions in machine language. This coded language, which can be understood and executed directly by the computer without conversion or translation, consists of binary digits representing operation codes and memory addresses. Because it is made up of strings of Is and Os, machine language is difficult for humans to understand or write. Assembly language was devised for greater convenience. It enabled programmers to express instructions in alphabetic symbols (e.g., AD for add and SUB for subtract) rather than in numbers.

Although assembly language with its mnemonic code was easier to use than machine language, it was clearly desirable to develop programming languages that more closely resembled human communication. The first so-called high-level language was FORTRAN (acronym for Formula Translation), invented in 1956. FORTRAN was well suited to scientists and mathematicians because it was similar to mathematical notations. It did, however, present some difficulty for those in nonmathematically oriented fields. As a result, a more practical programming language known as COBOL (Common Business-Oriented Language) was devised several years later (1960). COBOL employs words and syntax resembling those of ordinary English. Later, other languages even easier to learn and use were introduced. BASIC (Beginner's All-Purpose Symbolic Instruction Code), for example, can be readily mastered by the layperson and is used extensively in schools, businesses, and homes for microcomputer programming. C is a high-level language that can function as an assembly language; much commercial software is written in this flexible language. Another versatile language widely used for microcomputer as well as minicomputer applications is Pascal (probably named for the French scientist-philosopher Blaise Pascal).

Other high-level programming languages possess unique features that make each one suitable for a specific application. Some examples are APT (Automatically Programmed Tools), for numerical control of industrial machine tools, and GPSS (General-Purpose Simulation System), for constructing simulation models. LISP (List Processing) can be used to manipulate symbols and lists rather than numeric data; it is often used in artificial-intelligence applications. Fourth-generation languages (4 GLs) are closer to human language than are high-level (or third-generation) languages. They are used primarily for database management or as query languages; examples include FOCUS, SQL (Structured Query Language), and dBASE. Object-oriented programming languages, such as C++ and Smalltalk, write programs incorporating self-contained collections of data structure or computational instructions (called “objects”). New programs can be written by reassembling and manipulating the objects.

Compilers

A compiler is a program that translates code written in a high-level programming language into machine executable code (machine language). FIG. 1 illustrates a compiler which translates program source code into computer readable bytecode. The compiler 110 comprises a parser 101, a translator 103, and a code generator 105. The parser 101 receives input in the form of source code 100 and generates a high-level representation 102 of the program code. This high-level representation 102 may include, for example, a list of statements sorted by order of execution and a list of unique variable identifiers.

The translator 103 receives the high level representation 102 and translates the operations into a sequential representation (or intermediate form) 104 that describes the program operations. The sequential representation 104 is transformed by code generation process 105 into executable code 106 for a target simulation system. The code generator may implement one or more optimization techniques (e.g., changing the sequence of executed statements).

In statically typed languages, the type of an object is determined when the program is compiled. In statically typed programming languages that have a size of or type of operator, the operator is evaluated to a constant at compile time. However, in a dynamically typed programming language, the type and size information is sometimes not available until runtime.

### SUMMARY OF THE INVENTION

The present invention provides a method and apparatus for determining runtime size and type information in dynamically typed languages. In one embodiment of the present invention, a dynamic size and type system is added to a programming language. In one embodiment, an operator (e.g., sizeof) which returns a size associated with an object is dynamically executed at runtime. The operator is used to query an object to see what its size is.

In one embodiment, if the object is a vector, then the sizeof it is the number of elements held in the vector. In another embodiment, if the object is a string, its size is the length of the string. In yet another embodiment, if the object is an instance of a class, then the class may provide an instance of its own size operator to perform the calculation.

In another embodiment, an operator (e.g., typeof) which returns a type associated with an object is dynamically executed at runtime. The operator allows dynamic querying of the runtime type of an object. An object's type may change during execution of the program, so the type returned by the operator will change. In one embodiment, the operator evaluates to a value that is meaningful to the object to which it is applied. The value returned must be deterministic when applied to objects of the same type.

In different embodiments, however, the same value need not be returned for the objects of the same type. For example in one embodiment, if the object is a string, the string “string” is returned. In another embodiment, an integer value (e.g., 45) is returned if the object is a string. In one embodiment, if the object is an instance of a class, then the class may provide an instance of its own type operator to perform the calculation. In another embodiment, if a class does not provide an instance of its own type operator, the type of the class is returned as a default.

### BRIEF DESCRIPTION OF THE DRAWINGS

These and other features, aspects and advantages of the present invention will become better understood with regard to the following description, appended claims and accompanying drawings where:

FIG. 1 is a block diagram of a compiler.

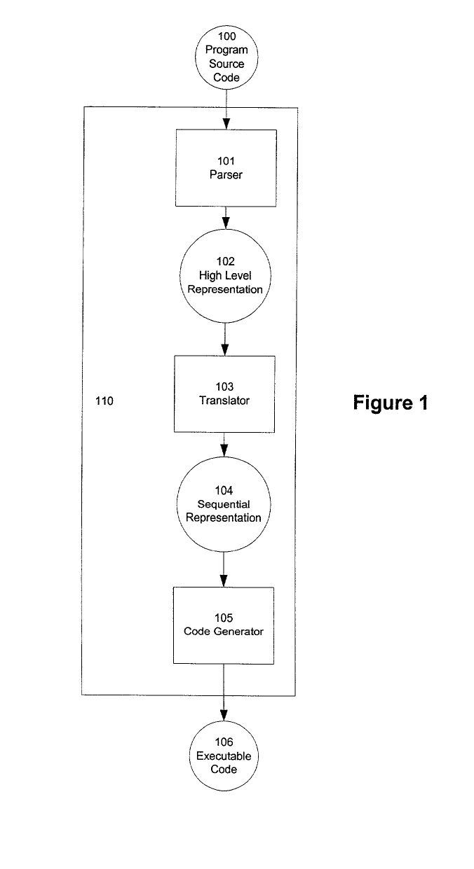

FIG. 2 is a flow diagram of the process of determining the size of an object in accordance with one embodiment of the present invention.

FIG. 3 is a flow diagram of the process of determining the size of a vector in accordance with one embodiment of the present invention.

FIG. 4 is a flow diagram of the process of determining the size of a string in accordance with one embodiment of the present invention.

FIG. 5 is a flow diagram of the process of determining the size of a class in accordance with one embodiment of the present invention.

FIG. 6 is a flow diagram of the process of determining the size of an object when the object size changes during program execution in accordance with one embodiment of the present invention.

FIG. 7 is a flow diagram of the process of determining the type of an object in accordance with one embodiment of the present invention.

FIG. 8 is a flow diagram of the process of determining the type of an object when the object type changes during program execution in accordance with one embodiment of the present invention.

FIG. 9 is a block diagram of a general purpose computer.

### DETAILED DESCRIPTION OF THE INVENTION

The invention is a method and apparatus for determining runtime size and type information in dynamically typed languages. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Dynamic Size Operator

In one embodiment of the present invention, a dynamic size and type system is added to a programming language. In one embodiment, an operator (e.g., sizeof) which returns a size associated with an object is dynamically executed at runtime. The operator is used to query an object to see what its size is.

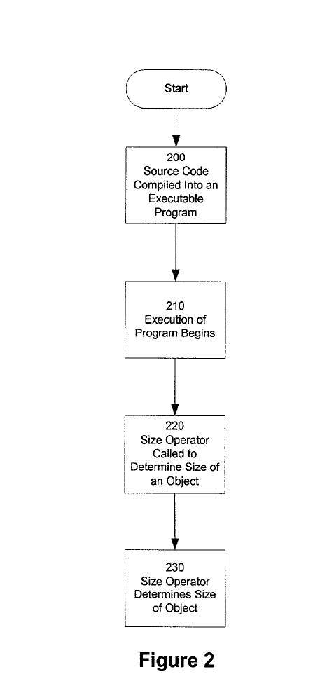

FIG. 2 illustrates the process of determining the sizeof an object in accordance with one embodiment of the present invention. At block 200, the source code is compiled into an executable program. At block 210, execution of the program begins. At block 220, the size operator is called to determine the sizeof an object. At block 230, the size operator determines the sizeof the object.

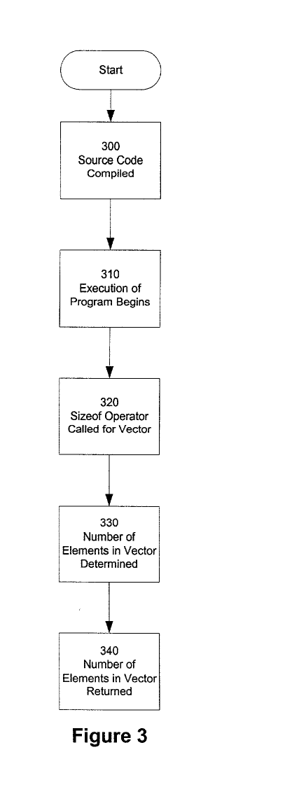

In one embodiment, if the object is a vector, then the sizeof it is the number of elements held in the vector. FIG. 3 illustrates the process of determining the sizeof a vector. At block 300, the source code is compiled. At block 310, execution of the program begins. At block 320, the sizeof operator is called for a vector. At block 330, the number of elements in the vector is determined. At block 340, the number of elements in the vector is returned.

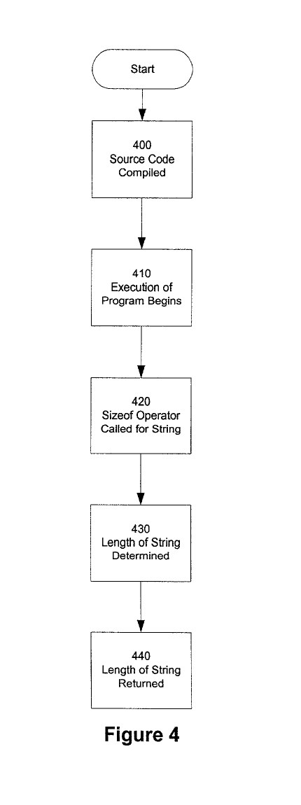

In another embodiment, if the object is a string, its size is the length of the string. FIG. 4 illustrates the process of determining the sizeof a string. At block 400, the source code is compiled. At block 410, execution of the program begins. At block 420, the sizeof operator is called for a string. At block 430, the length of the string is determined. At block 440, the length of the string is returned.

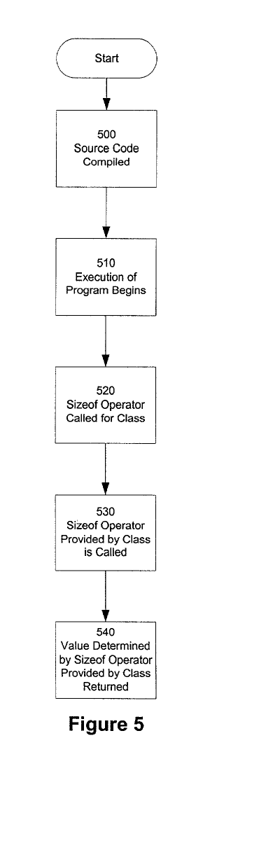

In yet another embodiment, if the object is an instance of a class, then the class may provide an instance of its own size operator to perform the calculation. FIG. 5 illustrates the process of determining the sizeof a class. At block 500, the source code is compiled. At block 510, execution of the program begins. At block 520, the sizeof operator is called for a class. At block 530, the sizeof operator provided by the class is called. At block 540, the value determined by the sizeof operator provided by the class is returned.

For example, in the code below, a class of type X is created, and X provides its own size operator, “sizeof”.

var s = “hello”;
class X {

private var value;
public operator sizeof( ) {

return sizeof (value);

}

| | |
|---|---|
| } | |
| var x = new X( ); | |
| sizeof(s); | // equal to 5 |
| sizeof(x); | // equal to sizeof(value) |

The “sizeof(s)” statement evaluates at runtime to 5 in this example because “s” is a string of length 5. The “sizeof(x)” statement evaluates to the size associated with the variable “value”. However, in a more complicated example, the values stored by “s” and “value” could be changed.

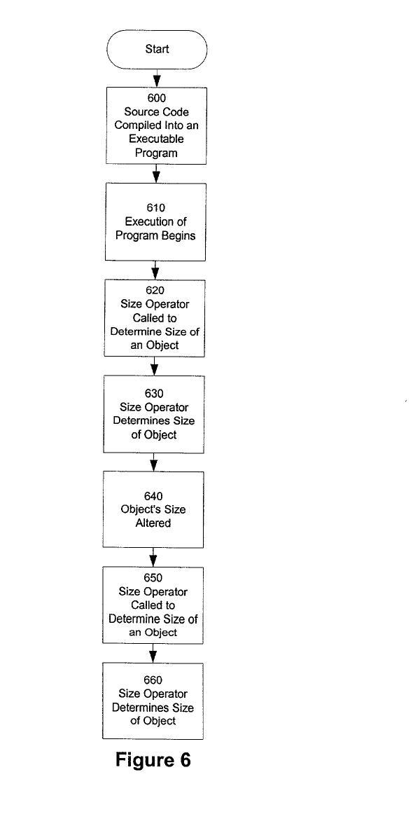

FIG. 6 illustrates the process of determining the sizeof an object when the object size changes during program execution in accordance with one embodiment of the present invention. At block 600, the source code is compiled into an executable program. At block 610, execution of the program begins. At block 620, the size operator is called to determine the sizeof an object. At block 630, the size operator determines the sizeof the object. At block 640, the object's size is altered. At block 650, the size operator is called to determine the sizeof an object. At block 660, the size operator determines the new sizeof the object.

Dynamic Type Operator

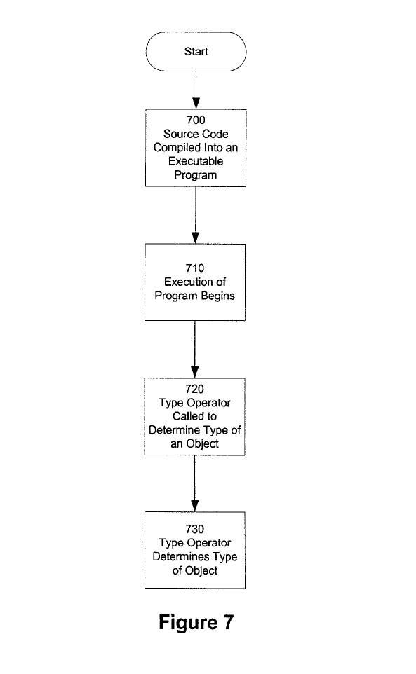

In another embodiment, an operator (e.g., typeof) which returns a type associated with an object is dynamically executed at runtime. The operator allows dynamic querying of the runtime type of an object. FIG. 7 illustrates the process of determining the type of an object in accordance with one embodiment of the present invention. At block 700, the source code is compiled into an executable program. At block 710, execution of the program begins. At block 720, the type operator is called to determine the type of an object. At block 730, the type operator determines the type of the object.

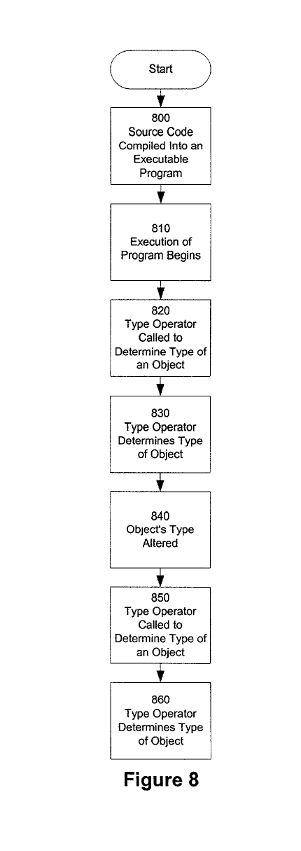

An object's type may change during execution of the program, so the type returned by the operator will change. FIG. 8 illustrates the process of determining the type of an object when the object type changes during program execution in accordance with one embodiment of the present invention. At block 800, the source code is compiled into an executable program. At block 810, execution of the program begins. At block 820, the type operator is called to determine the type of an object. At block 830, the type operator determines the type of the object. At block 840, the object's type is altered. At block 850, the type operator is called to determine the type of an object. At block 860, the type operator determines the new type of the object.

In one embodiment, the operator evaluates to a value that is meaningful to the object to which it is applied. The value returned must be deterministic when applied to objects of the same type in any one embodiment. However, different embodiments need not return the same value for the objects of the same type. For example in one embodiment, if the object is a string, the value “string” is returned because it identifies the object's type. In another embodiment, the integer value 45 is returned if the object is a string to identify the object's type.

In one embodiment, if the object is an instance of a class, then the class may provide an instance of its own type operator to perform the calculation. In another embodiment, if a class does not provide an instance of its own type operator, the type of the class is returned as a default.

For example, in the code below, a class of type X is created, and X provides its own type operator, “typeof”.

var s = “hello”;
class X {

public operator typeof() {

return “whatever”;

}

| | |
|---|---|
| } | |
| var x = new X( ); | |
| sizeof(s); | // equal to “string” |
| sizeof(x); | // equal to “whatever” |

The “typeof(s)” statement evaluates at runtime to “string” in this example because “s” is of type “string”. The “typeof(x)” statement evaluates to “whatever” because “x” is a member of class X and class X provides its own typeof operator which returns “whatever” as the type. However, in a more complicated example, the values stored by “s” and “x” could be changed, possibly resulting in a different returned value. For example, if “x” is set to be a value of type “integer”, a new call to “typeof(x)” would return “integer”. Similarly, if “s” is set equal to a member of class Y and class Y does not provide its own instance of the typeof operator, a new call to “typeof(s)” would return “Y”.

Embodiment of Computer Execution Environment (Hardware)

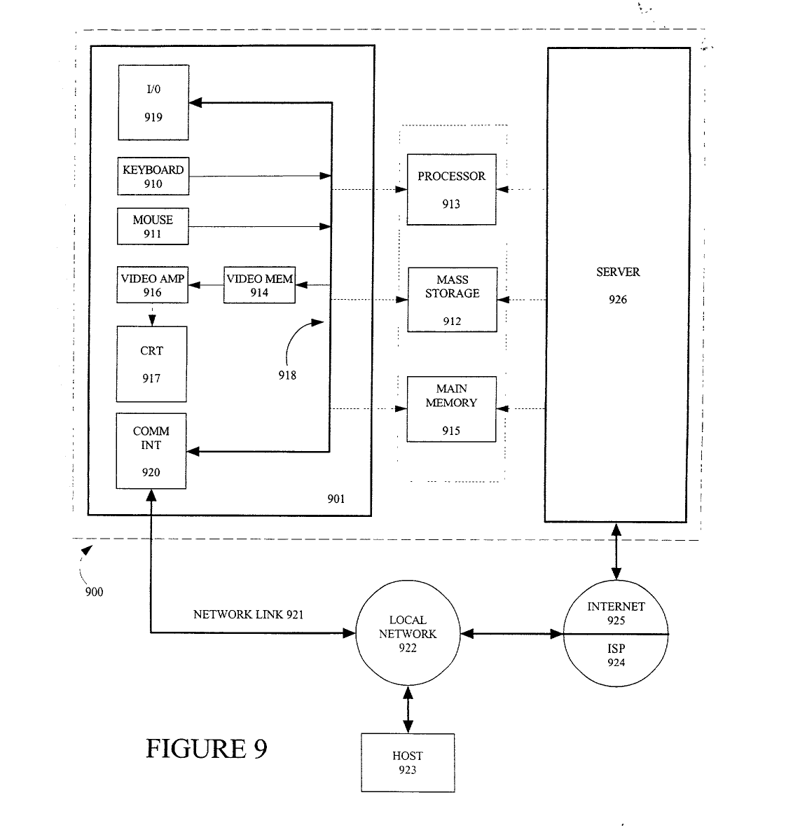

An embodiment of the invention can be implemented as computer software in the form of computer readable program code executed in a general purpose computing environment such as environment 900 illustrated in FIG. 9, or in the form of bytecode class files executable within a Java™ run time environment running in such an environment, or in the form of bytecodes running on a processor (or devices enabled to process bytecodes) existing in a distributed environment (e.g., one or more processors on a network), or in the form of bytecodes running on a PDA. A keyboard 910 and mouse 911 are coupled to a system bus 918. The keyboard and mouse are for introducing user input to the computer system and communicating that user input to central processing unit (CPU) 913. Other suitable input devices, a touch-sensitive display for example, may be used in addition to, or in place of, the mouse 911 and keyboard 910. I/O (input/output) unit 919 coupled to bi-directional system bus 918 represents such I/O elements as a printer, A/V (audio/video) I/O, etc.

Computer 901 may include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals which carry digital data streams representing various types of information.

Network link 921 typically provides data communication through one or more networks to other data devices. For example, network link 921 may provide a connection through local network 922 to local server computer 923 or to data equipment operated by ISP 924. ISP 924 in turn provides data communication services through the world wide packet data communication network now commonly referred to as the “Internet” 925. Local network 922 and Internet 925 both use electrical, electromagnetic or optical signals which carry digital data streams. The signals through the various networks and the signals on network link 921 and through communication interface 920, which carry the digital data to and from computer 900, are exemplary forms of carrier waves transporting the information.

Processor 913 may reside wholly on client computer 901 or wholly on server 926 or processor 913 may have its computational power distributed between computer 901 and server 926. Server 926 symbolically is represented in FIG. 9 as one unit, but server 926 can also be distributed between multiple “tiers”. In one embodiment, server 926 comprises a middle and back tier where application logic executes in the middle tier and persistent data is obtained in the back tier. In the case where processor 913 resides wholly on server 926, the results of the computations performed by processor 913 are transmitted to computer 901 via Internet 925, Internet Service Provider (ISP) 924, local network 922 and communication interface 920. In this way, computer 901 is able to display the results of the computation to a user in the form of output.

Computer 901 includes a video memory 914, main memory 915 and mass storage 912, all coupled to bidirectional system bus 918 along with keyboard 910, mouse 911 and processor 913. As with processor 913, in various computing environments, main memory 915 and mass storage 912, can reside wholly on server 926 or computer 901, or they may be distributed between the two. Examples of systems where processor 913, main memory 915, and mass storage 912 are distributed between computer 901 and server 926 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processor 913, main memory 915, video memory 914 and mass storage 912. Alternatively, multiplex data/address lines may be used instead of separate data and address lines.

In one embodiment of the invention, the processor 913 is a SPARC microprocessor from Sun Microsystems, Inc., a microprocessor manufactured by Motorola, such as the 680×0 processor, a microprocessor manufactured for use in a PDA, or a microprocessor manufactured by Intel, such as the 80×86 or Pentium processor. However, any other suitable microprocessor or microcomputer may be utilized. Main memory 915 is comprised of dynamic random access memory (DRAM), and bytecodes for one embodiment of the invention is stored in a portion 927 of main memory 915 during program execution. Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and may be implemented by any suitable apparatus. This circuitry converts pixel data stored in video memory 914 to a raster signal suitable for use by monitor 917. Monitor 917 is a type of monitor suitable for displaying graphic images.

Computer 901 can send messages and receive data, including program code, through the network(s), network link 921, and communication interface 920. In the Internet example, remote server computer 926 might transmit a requested code for an application program through Internet 925, ISP 924, local network 922 and communication interface 920. The received code may be executed by processor 913 as it is received, and/or stored in mass storage 912, or other non-volatile storage for later execution. In this manner, computer 900 may obtain application code in the form of a carrier wave. Alternatively, remote server computer 926 may execute applications using processor 913, and utilize mass storage 912, and/or video memory 915. The results of the execution at server 926 are then transmitted through Internet 925, ISP 924, local network 922 and communication interface 920. In this example, computer 901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for determining runtime size and type information in dynamically typed languages is described in conjunction with one or more specific embodiments. The invention is defined by the following claims and their full scope and equivalents.

1. A method for determining a size value associated with an object at runtime comprising:
executing a computer program;
associating a size value with an object during execution of said computer program; and
retrieving said size value when a size operator is executed for said object during execution of said computer program.

2. The method of claim 1 wherein said size value is a number of characters in said object, if said object is a string.

3. The method of claim 1 wherein said size value is a number of elements in said object, if said object is an array.

4. The method of claim 1 wherein said size value is a value determined by a function of said object, if said object is an instance of a class.

5. The method of claim 4 wherein said retrieving comprises:
providing an instance of said size operator for said class; and
calling said instance of said size operator.

6. A method for determining a type value associated with an object at runtime comprising:
executing a computer program;
associating a type value with an object during execution of said computer program; and
retrieving said type value when a type operator is executed for said object during execution of said computer program.

7. The method of claim 6 wherein said type value is “string”, if said object is a string.

8. The method of claim 6 wherein said type value is a number, if said object is a string.

9. The method of claim 6 wherein said type value is a value determined by a function of said object, if said object is an instance of a class.

10. The method of claim 9 wherein said retrieving comprises:
providing an instance of said type operator for said class; and
calling said instance of said type operator.

11. A runtime size information determiner comprising:
an association unit configured to associate a size value with an object during execution of a computer program; and
a retrieval unit configured to retrieve said size value when a size operator is executed for said object during execution of said computer program.

12. The runtime size information determiner of claim 11 wherein said size value is a number of characters in said object, if said object is a string.

13. The runtime size information determiner of claim 11 wherein said size value is a number of elements in said object, if said object is an array.

14. The runtime size information determiner of claim 11 wherein said size value is a value determined by a function of said object, if said object is an instance of a class.

15. The runtime size information determiner of claim 14 wherein said retrieval unit comprises:
an instance of said size operator for said class; and
an instance calling unit configured to call said instance of said size operator.

16. A runtime type information determiner comprising:
an association unit configured to associate a type value with an object during execution of a computer program; and
a retrieval unit configured to retrieve said type value when a type operator is executed for said object during execution of said computer program.

17. The runtime type information determiner of claim 16 wherein said type value is “string”, if said object is a string.

18. The runtime type information determiner of claim 16 wherein said type value is a number, if said object is a string.

19. The runtime type information determiner of claim 16 wherein said type value is a value determined by a function of said object, if said object is an instance of a class.

20. The runtime type information determiner of claim 19 wherein said retrieval unit comprises:
an instance of said type operator for said class; and
an instance calling unit configured to call said instance of said type operator.

21. A computer program product comprising:
a computer usable medium having computer readable program code embodied therein configured to determine a size value associated with an object at runtime, said computer program product comprising:
computer readable code configured to cause a computer to execute a computer program;
computer readable code configured to cause a computer to associate said size value with an object during execution of said computer program; and
computer readable code configured to cause a computer to retrieve said size value when a size operator is executed for said object during execution of said computer program.

22. The computer program product of claim 21 wherein said size value is a number of characters in said object, if said object is a string.

23. The computer program product of claim 21 wherein said size value is a number of elements in said object, if said object is an array.

24. The computer program product of claim 21 wherein said size value is a value determined by a function of said object, if said object is an instance of a class.

25. The computer program product of claim 24 wherein said retrieval unit comprises:
computer readable code configured to cause a computer to provide an instance of said size operator for said class; and
computer readable code configured to cause a computer to call said instance of said size operator.

26. A computer program product comprising:
a computer usable medium having computer readable program code embodied therein configured to determine a type value associated with an object at runtime, said computer program product comprising:
computer readable code configured to cause a computer to execute a computer program;
computer readable code configured to cause a computer to associate said type value with an object during execution of said computer program; and
computer readable code configured to cause a computer to retrieve said type value when a type operator is executed for said object during execution of said computer program.

27. The computer program product of claim 26 wherein said type value is “string”, if said object is a string.

28. The computer program product of claim 26 wherein said type value is a number, if said object is a string.

29. The computer program product of claim 26 wherein said type value is a value determined by a function of said object, if said object is an instance of a class.

30. The computer program product of claim 29 wherein said retrieval unit comprises:
computer readable code configured to cause a computer to provide an instance of said type operator for said class; and
computer readable code configured to cause a computer to call said instance of said type operator.
